(19) United States
(12) Patent Application Publication
(10) Pub. No.: US 2026/0045412 A1
(43) Pub. Date: Feb. 12, 2026

(54) MULTILAYER ELECTRONIC COMPONENT

(71) Applicant: SAMSUNG ELECTRO-MECHANICS CO., LTD., Suwon-si (KR)

(72) Inventors: Ho Sam CHOI, Suwon-si (KR); Dae Jin SHIM, Suwon-si (KR); Jung Jin PARK, Suwon-si (KR); Hyo Sung CHOI, Suwon-si (KR); Yong Hwa LEE, Suwon-si (KR); Dong Jun JUNG, Suwon-si (KR); Jong Ho LEE, Suwon-si (KR)

(73) Assignee: SAMSUNG ELECTRO-MECHANICS CO., LTD., Suwon-si (KR)

(21) Appl. No.: 19/057,248

(22) Filed: Feb. 19, 2025

(30) Foreign Application Priority Data
Aug. 12, 2024 (KR) 10-2024-0107344

(51) Int. Cl. H01G 4/12; H01G 4/008; H01G 4/012; H01G 4/224; H01G 4/30

(52) U.S. Cl. CPC H01G 4/1209; H01G 4/012; H01G 4/224; H01G 4/008; H01G 4/30

(57) ABSTRACT

A multilayer electronic component includes a body including a capacitance formation portion including a dielectric layer and an internal electrode alternately disposed with the dielectric layer in a first direction, and a cover portion disposed on both end surfaces of the capacitance formation portion in the first direction; and an external electrode disposed on the body, wherein the dielectric layer and the cover portion include barium (Ba) and titanium (Ti), the cover portion includes an inner cover portion disposed in a region adjacent to the capacitance formation portion, and an outer cover portion disposed to contact the inner cover portion, and the outer cover portion has a different composition from the inner cover portion, and includes gallium (Ga).

### CROSS-REFERENCE TO RELATED APPLICATION(S)

This application claims benefit of priority to Korean Patent Application No. 10-2024-0107344 filed on Aug. 12, 2024 in the Korean Intellectual Property Office, the disclosure of which is incorporated herein by reference in its entirety.

### TECHNICAL FIELD

The present disclosure relates to a multilayer electronic component.

A multilayer ceramic capacitor (MLCC), a multilayer electronic component, may be a chip condenser mounted on the printed circuit boards of various types of electronic products such as image display devices including a liquid crystal display (LCD), a plasma display panel (PDP), or the like, a computer, a smartphone, a mobile phone, or the like, serving to charge or discharge electricity therein or therefrom.

Such a multilayer ceramic capacitor may be used as a component of various electronic devices, as the multilayer ceramic capacitor has a small size with high capacitance and is easily mounted. As various electronic devices such as computers, mobile devices, or the like have been miniaturized and implemented with high-output, demand for miniaturization and high capacitance of the multilayer ceramic capacitors has increased.

As miniaturization and high capacitance progress, the need to protect a region forming capacitance is increasing, and is being improved by adding a margin region surrounding the region forming capacitance. However, as a structural design is continuously changed to achieve miniaturization and high capacitance, the region forming capacitance may increase and the margin region protecting the region forming capacitance may decrease, which may cause problems of weakening moisture resistance reliability and strength of the multilayer ceramic capacitor.

To improve this, a grain size of a cover portion may be designed to be small and uniform. However, when the grain size is reduced, since withstand voltage characteristics may be improved, but side effects of decreasing densification to increase pores and decreasing reliability may be manifest.

### SUMMARY

An aspect of the present disclosure is to provide a multilayer electronic component having improved moisture resistance reliability by improving densification of a cover portion to suppress generation of pores.

An aspect of the present disclosure is to provide a multilayer electronic component having improved withstand voltage characteristics.

Various problems to be solved by the present disclosure are not limited to the above-described contents, and may be more easily understood in the process of explaining specific embodiments of the present disclosure.

According to an aspect of the present disclosure, a multilayer electronic component includes a body including a capacitance formation portion including a dielectric layer and internal electrodes alternately disposed with the dielectric layer in a first direction, and a cover portion disposed on both end surfaces of the capacitance formation portion in the first direction; and an external electrode disposed on the body, wherein the dielectric layer and the cover portion include barium (Ba) and titanium (Ti), the cover portion includes an inner cover portion disposed in a region adjacent to the capacitance formation portion, and an outer cover portion disposed to contact the inner cover portion, and the outer cover portion has a first composition that is different composition from a second composition of the inner cover portion, and the outer cover portion includes gallium (Ga).

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 schematically illustrates a perspective view of a multilayer electronic component according to an embodiment of the present disclosure.

FIG. 2 schematically illustrates an exploded perspective view illustrating a stack structure of an internal electrode.

FIG. 3 schematically illustrates a cross-sectional view of FIG. 1, taken along line I-I′.

FIG. 4 schematically illustrates a cross-sectional view of FIG. 1, taken along line II-II′.

FIG. 5 schematically illustrates a cross-sectional view of a multilayer electronic component according to another embodiment of the present disclosure, corresponding to a cross-section of FIG. 1, taken along line II-II′.

FIGS. 6A to 6D are images taken by a scanning electron microscope (SEM) of cross-sections of cases in which gallium (Ga) is added in different amounts to an outer cover portion in an embodiment of the present disclosure.

FIG. 7A is a bar graph illustrating an average size of dielectric grains in an inner cover portion of an example, and FIG. 7B is a bar graph illustrating an average size of dielectric grains in an outer cover portion of the same example.

FIG. 8 is a bar graph illustrating porosity (%) of an outer region of a cover portion of a comparative example, and a bar graph illustrating porosity (%) of an outer cover portion of an example.

FIG. 9A is a graph for evaluating moisture resistance reliability of a comparative example, and FIG. 9B is a graph for evaluating moisture resistance reliability of an example.

### DETAILED DESCRIPTION

Hereinafter, embodiments of the present disclosure will be described with reference to specific embodiments and the accompanying drawings. However, embodiments of the present disclosure may be modified into various other forms, and the scope of the present disclosure is not limited to the embodiments described below. Further, embodiments of the present disclosure may be provided for a more complete description of the present disclosure to the ordinary artisan. Therefore, shapes, sizes, and the like, of the elements in the drawings may be exaggerated for clarity of description, and the elements denoted by the same reference numerals in the drawings may be the same elements.

In addition, in order to clearly explain the present disclosure in the drawings, portions not related to the description will be omitted for clarification of the present disclosure, and a thickness may be enlarged to clearly illustrate layers and regions. The same reference numerals will be used to designate the same components in the same reference numerals. Further, throughout the specification, when an element is referred to as “comprising” or “including” an element, it means that the element may further include other elements as well, without departing from the other elements, unless specifically stated otherwise.

In the drawings, a first direction may be defined as a stack direction or a thickness T direction, a second direction may be defined as a length L direction, and a third direction may be defined as a width W direction.

### Multilayer Electronic Component

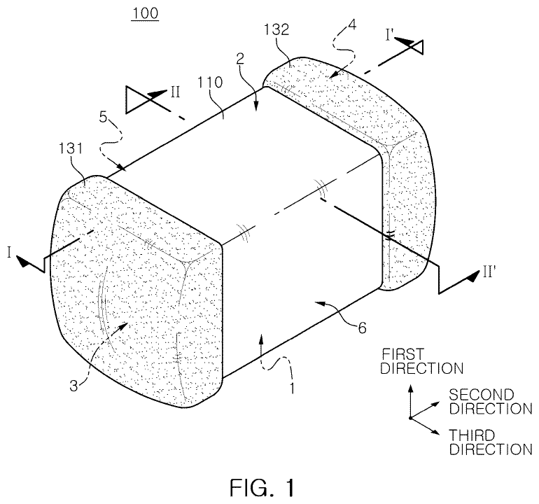

FIG. 1 schematically illustrates a perspective view of a multilayer electronic component according to an embodiment of the present disclosure.

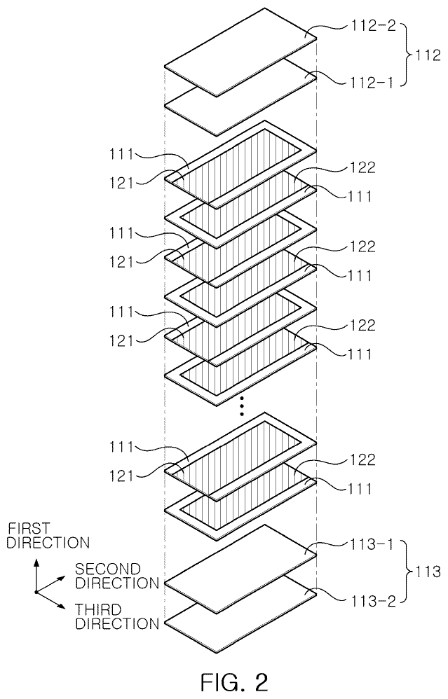

FIG. 2 schematically illustrates an exploded perspective view illustrating a stack structure of an internal electrode.

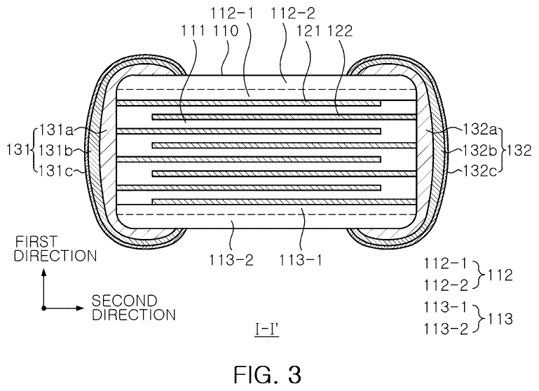

FIG. 3 schematically illustrates a cross-sectional view of FIG. 1, taken along line I-I′.

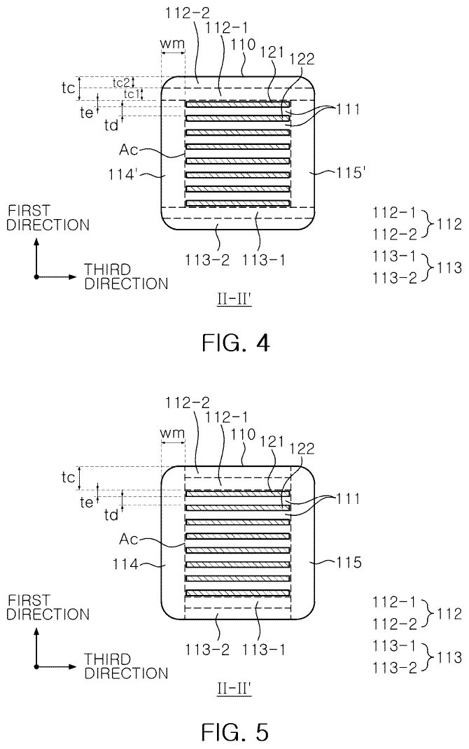

FIG. 4 schematically illustrates a cross-sectional view of FIG. 1, taken along line II-II′.

FIG. 5 schematically illustrates a cross-sectional view of a multilayer electronic component according to another embodiment of the present disclosure, corresponding to a cross-section of FIG. 1, taken along line II-II′.

Hereinafter, with reference to FIGS. 1 to 5, a multilayer electronic component according to an embodiment of the present disclosure will be described in detail. A multilayer ceramic capacitor will be described as an example of a multilayer electronic component, but the example embodiment may also be applied to various electronic products using a dielectric composition, such as an inductor, a piezoelectric element, a varistor, a thermistor, or the like.

A multilayer electronic component 100 according to an embodiment of the present disclosure includes a body 110 including a capacitance formation portion Ac including a dielectric layer 111 and an internal electrode (121 and 122) alternately disposed with the dielectric layer 111 in a first direction; and a cover portion (112 and 113) disposed on both end surfaces of the capacitance formation portion Ac in the first direction; and an external electrode (131 and 132) disposed on the body 110, wherein the dielectric layer 111 and the cover portion (112 and 113) include barium (Ba) and titanium (Ti), and the cover portion (112 and 113) includes an inner cover portion (112-1 and 113-1) disposed in a region adjacent to the capacitance formation portion Ac, and an outer cover portion (112-2 and 113-2) disposed on the inner cover portion (112-1 and 113-1), and the outer cover portion (112-2 and 113-2) has a different composition (e.g., first composition) from the composition (e.g., second composition) of the inner cover portion (112-1 and 113-1), and includes gallium (Ga). As used herein, the first composition and the second composition may be considered to be different from each other when a difference in the contents of the same element in the first and second compositions is, relative to 100 moles of titanium (Ti), more than ±0.2 mol %, more than ±0.3 mol %, or more than ±1 mol %.

The body 110 may have the dielectric layers 111 and the internal electrode (121 and 122), alternately stacked.

More specifically, the body 110 may include a first internal electrode 121 and a second internal electrode 122, disposed in the body 110 and alternately arranged to face each other, with the dielectric layer 111 therebetween, to include a capacitance formation portion Ac forming capacitance.

Although a specific shape of the body 110 is not particularly limited, the body 110 may have a hexahedral shape or the like, as illustrated. Due to shrinkage of ceramic powder particles included in the body 110 during a sintering process, the body 110 may not have a perfectly straight hexahedral shape, but may have a substantially hexahedral shape.

The body 110 may include first and second surfaces 1 and 2 opposing each other in a first direction, third and fourth surfaces 3 and 4 connected to the first and second surfaces 1 and 2 and opposing each other in a second direction, and fifth and sixth surfaces 5 and 6 connected to the first to fourth surfaces 1, 2, 3, and 4 and opposing each other in a third direction.

A plurality of dielectric layers 111 forming the body 110 may be in a sintered state, and a boundary between adjacent dielectric layers 111 may be integrated to such an extent that it may be difficult to identify the same without using a scanning electron microscope (SEM).

A raw material for forming the dielectric layer 111 is not particularly limited, as long as sufficient capacitance may be obtained therewith. In general, a perovskite (ABO₃)-based material may be used, for example, a barium titanate-based material, a lead composite perovskite-based material, a strontium titanate-based material, or the like may be used. The barium titanate-based material may include a BaTiO₃-based ceramic powder, and examples of the ceramic powder may include BaTiO₃, or (Ba₁₋ₓCaₓ)TiO₃(0<x<1), Ba(Ti_{1-y}Ca_{y})O₃(0<y<1), (Ba₁₋ₓCaₓ)(Ti_{1-y}Zr_{y})O₃(0<x<1, 0<y<1), Ba(Ti_{1-y}Zr_{y})O₃(0<y<1), or the like, in which calcium (Ca), zirconium (Zr), or the like is partially dissolved in BaTiO₃, or the like.

In addition, various ceramic additives, organic solvents, binders, dispersants, or the like may be added to the powder of barium titanate (BaTiO₃), and the like, as the raw material for forming the dielectric layer 111, according to the purpose of the present disclosure.

In addition, since the dielectric layer 111 may be formed using a dielectric material such as barium titanate (BaTiO₃), and may thus include a dielectric microstructure after sintering. The dielectric microstructure may include a plurality of dielectric grains, grain boundaries disposed between adjacent dielectric grains among the dielectric grains, and triple points disposed at points at which three or more dielectric grains among the dielectric grains are in contact, and may include a plurality of each thereof.

In addition, in the present disclosure, as an example of a more specific method for measuring amounts of elements included in each configuration of the multilayer electronic component 100, components may be analyzed using an energy dispersive X-ray spectroscopy (EDS) mode of a scanning electron microscope (SEM), an EDS mode of a transmission electron microscope (TEM), or an EDS mode of a scanning transmission electron microscope (STEM). First, a thinned analysis sample may be prepared using a focused ion beam (FIB) device in a region including a dielectric microstructure, among cross-sections of the body, the cover portion, or a side margin portion, in which sintering is completed. The thinned sample may be subjected to Xe or Ar ion milling to remove a damage layer on a surface, and then each component to be measured may be mapped from images obtained using SEM-EDS, TEM-EDS, or STEM-EDS to conduct a qualitative/quantitative analysis. In this case, a qualitative/quantitative analysis graph of each component may be expressed by converting the same into a mass percentage (wt %), an atomic percentage (at %), or a mole percentage (mol %) of each element. In this case, the number of moles of a specific component may be expressed by converting the same into the number of moles of another specific component.

In another method, a chip may be pulverized to select a region including the dielectric microstructure, and the selected region including the dielectric microstructure may be analyzed for the components of the region including the dielectric microstructure using a device such as an inductively coupled plasma optical emission spectrometer (ICP-OES), an inductively coupled plasma mass spectrometer (ICP-MS), or the like. Other methods and/or tools appreciated by one of ordinary skill in the art, even if not described in the present disclosure, may also be used.

In the present disclosure, to distinguish from a dielectric layer included in a cover portion (112 and 113) and a side margin portion (114 and 115), described later, the dielectric layer 111 included in the capacitance formation portion Ac may be defined as a first dielectric layer 111, the dielectric layer included in the cover portion (112 and 113) may be defined as a second dielectric layer, and the dielectric layer included in the side margin portion (114 and 115) may be defined as a third dielectric layer.

In an embodiment of the present disclosure, the dielectric layer 111 of the capacitance formation portion Ac may not include gallium (Ga). In this case, the fact that the dielectric layer 111 of the capacitance formation portion Ac does not include gallium (Ga) may refer to a state in which a dielectric slurry or a dielectric green sheet does not include gallium (Ga) before sintering the dielectric layer 111, and may refer to a state in which the dielectric layer 111 located in a central region of the capacitance formation portion Ac does not include gallium (Ga).

For example, the dielectric layer 111 of the capacitance formation portion Ac being free of gallium (Ga) may refer to a state in which, even when gallium (Ga), included in the outer cover portion (112-2 and 113-2) as described below, undergoes a sintering process such as high-temperature heat treatment or the like, gallium (Ga) does not diffuse into a region of the dielectric layer 111 of the capacitance formation portion Ac, adjacent to the cover portion (112 and 113) of the capacitance formation portion Ac, and the dielectric layer 111 located in the central region of the capacitance formation portion Ac does not include gallium (Ga).

For example, the dielectric layer 111 of the capacitance formation portion Ac being free of gallium (Ga) may refer to a state in which, when a 10 μm×10 μm region located in a central region in the first and second directions is observed in an SEM-EDS mode, a TEM-EDS mode, or an STEM-EDS mode, based on the first and second direction cross-sections at a center of the body 110 in the third direction, gallium (Ga) is not detected or gallium (Ga) is detected at less than 0.1 at %.

A thickness td of the dielectric layer 111 is not specifically limited.

To secure reliability of the multilayer electronic component 100 under a high-voltage environment, the thickness td of the dielectric layer 111 may be 10.0 μm or less. In addition, to achieve miniaturization and high capacitance of the multilayer electronic component 100, the thickness td of the dielectric layer 111 may be 3.0 μm or less, and to more easily achieve ultra-miniaturization and high capacitance, the thickness td of the dielectric layer 111 may be 1.0 μm or less, preferably 0.6 μm or less, and more preferably 0.4 μm or less.

In this case, the thickness td of the dielectric layer 111 may be a concept including a thickness of at least one of the plurality of dielectric layers, or may be a concept including thicknesses of all dielectric layers.

In this case, the thickness td of the dielectric layer 111 may refer to the thickness td of the dielectric layer 111 disposed between the first and second internal electrodes 121 and 122.

The thickness td of the dielectric layer 111 may refer to a first direction dimension of the dielectric layer 111. In addition, the thickness td of the dielectric layer 111 may refer to an average thickness td of the dielectric layer 111 and may refer to a first direction average dimension of the dielectric layer 111.

The first direction average dimension of the dielectric layer 111 may be measured by scanning images of first and second direction cross-sections of the body 110 with a scanning electron microscope (SEM) at 10,000× magnification. More specifically, the first direction average dimension of one dielectric layer 111 may refer to an average value calculated by measuring the first direction dimension at ten (10) equally spaced points in the second direction of one dielectric layer 111 in scanned images. The ten (10) equally spaced points may be designated in the capacitance formation portion Ac. In addition, when this average value measurement is extended to 10 dielectric layers 111 and an average value thereof is measured, the first direction average dimension of the dielectric layer 111 may be further generalized.

The internal electrode (121 and 122) may be alternately stacked with the dielectric layer 111.

The internal electrode (121 and 122) may include a first internal electrode 121 and a second internal electrode 122, and the first and second internal electrodes 121 and 122 may be alternately disposed to face each other with the dielectric layer 111 forming the body 110 interposed therebetween, and may be exposed to the third and fourth surfaces 3 and 4 of the body 110, respectively.

More specifically, the first internal electrode 121 may be spaced apart from the fourth surface 4 and exposed through the third surface 3, and the second internal electrode 122 may be spaced apart from the third surface 3 and exposed through the fourth surface 4. A first external electrode 131 may be disposed on the third surface 3 of the body 110 and connected to the first internal electrode 121, and a second external electrode 132 may be disposed on the fourth surface 4 of the body 110 and connected to the second internal electrode 122.

For example, the first internal electrode 121 may be connected to the first external electrode 131 without being connected to the second external electrode 132, and the second internal electrode 122 may be connected to the second external electrode 132 without being connected to the first external electrode 131. In this case, the first and second internal electrodes 121 and 122 may be electrically separated from each other by the dielectric layer 111 disposed therebetween.

The body 110 may be formed by alternately stacking and then sintering a first ceramic green sheet on which a first internal electrode paste is printed and a second ceramic green sheet on which a second internal electrode paste is printed.

A material forming the internal electrode (121 and 122) may not be particularly limited, and a material having excellent electrical conductivity may be used. For example, the internal electrode (121 and 122) may include one or more of nickel (Ni), copper (Cu), palladium (Pd), silver (Ag), gold (Au), platinum (Pt), tin (Sn), tungsten (W), titanium (Ti), and alloys thereof.

In addition, the internal electrode (121 and 122) may be formed by printing an internal electrode conductive paste including one or more of nickel (Ni), copper (Cu), palladium (Pd), silver (Ag), gold (Au), platinum (Pt), tin (Sn), tungsten (W), titanium (Ti), and alloys thereof on a ceramic green sheet. A method of printing the internal electrode conductive paste may use a screen printing method, a gravure printing method, or the like, and the present disclosure is not limited thereto.

A thickness the of the internal electrode (121 and 122) is not particularly limited.

To secure reliability of the multilayer electronic component 100 under a high-voltage environment, the thickness the of the internal electrode (121 and 122) may be 3.0 μm or less. In addition, to achieve miniaturization and high capacitance of the multilayer electronic component 100, the thickness the of the internal electrode (121 and 122) may be 1.0 μm or less, and to more easily achieve ultra-miniaturization and high capacitance, the thickness the of the internal electrode (121 and 122) may be 0.6 μm or less, and more preferably, 0.4 μm or less.

In this case, the thickness the of the internal electrode (121 and 122) may be a concept including a thickness the of at least one of a plurality of internal electrodes 121 and 122, or may be a concept including thicknesses the of all the internal electrodes 121 and 122.

In this case, the thickness the of the internal electrode (121 and 122) may refer to a first direction dimension of the internal electrode (121 and 122). In addition, the thickness the of the internal electrode (121 and 122) may refer to an average thickness the of the internal electrode (121 and 122), and may refer to a first direction average dimension of the internal electrode (121 and 122).

The first direction average dimension of the internal electrode (121 and 122) may be measured by scanning images of first and second direction cross-sections of the body 110 with a scanning electron microscope (SEM) at 10,000× magnification. More specifically, the first direction average dimension of one internal electrode may be an average value calculated by measuring the first direction dimension of one internal electrode at ten (10) equally spaced points in the second direction in the scanned images. The ten (10) equally spaced points may be designated in the capacitance formation portion Ac. In addition, when this average value measurement is extended to 10 internal electrode (121 and 122) and an average value thereof is measured, the first direction average dimension of the internal electrode may be further generalized. Other methods and/or tools appreciated by one of ordinary skill in the art, even if not described in the present disclosure, may also be used.

In an embodiment of the present disclosure, the thickness td of at least one of the plurality of dielectric layers 111 and the thickness the of at least one of the plurality of internal electrodes 121 and 122 may satisfy 2×te<td.

For example, the thickness td of one dielectric layer 111 may be greater than twice the thickness the of one of the internal electrode (121 and 122). Preferably, the average thickness td of the plurality of dielectric layers 111 may be greater than twice the average thickness the of the plurality of internal electrodes 121 and 122.

In general, for high-voltage electronic components, a major issue may be reliability due to a decrease in breakdown voltage (BDV) in a high-voltage environment.

To prevent a decrease in breakdown voltage in a high voltage environment, the average thickness td of the dielectric layer 111 may be made to be greater than twice the average thickness the of the internal electrode (121 and 122). Therefore, a thickness of the dielectric layer, which may be a distance between the internal electrodes, may increase, and breakdown voltage characteristics may be improved.

When the average thickness td of the dielectric layer 111 is less than twice the average thickness the of the internal electrode (121 and 122), an average thickness of the dielectric layer, which may be a distance between the internal electrodes, may be thin, to decrease breakdown voltage and occur a short circuit between internal electrodes.

The body 110 may include cover portions 112 and 113 disposed on both end-surfaces of the capacitance formation portion Ac in the first direction.

Specifically, the cover portions 112 and 113 may include a first cover portion 112 disposed on one surface of the capacitance formation portion Ac in the first direction, and a second cover portion 113 disposed on the other surface of the capacitance formation portion Ac in the first direction. More specifically, the cover portions 112 and 113 may include an upper cover portion 112 disposed above the capacitance formation portion Ac in the first direction, and a lower cover portion 113 disposed below the capacitance formation portion Ac in the first direction.

The first cover portion 112 and the second cover portion 113 may be formed by stacking a single dielectric layer 111 or two or more dielectric layers 111 on upper and lower surfaces of the capacitance formation portion Ac in the first direction, respectively, and may basically play a role in preventing damage to the internal electrode (121 and 122) due to physical or chemical stress.

The first cover portion 112 and the second cover portion 113 may not include the internal electrode (121 and 122), and may include the same dielectric material as the dielectric layer 111. For example, the upper cover portion 112 and the lower cover portion 113 may include a ceramic material, and may include, for example, a barium titanate (BaTiO₃)-based ceramic material. For example, the first cover portion 112 and the second cover portion 113 may include barium (Ba) and titanium (Ti).

In addition, the cover portion (112 and 113) may be formed using a dielectric material such as barium titanate (BaTiO₃), and may thus include a dielectric microstructure after sintering. The dielectric microstructure may include a plurality of dielectric grains, grain boundaries disposed between adjacent dielectric grains among the dielectric grains, and triple points disposed at points at which three or more dielectric grains among the dielectric grains are in contact, and may include a plurality of each thereof.

In an embodiment of the present disclosure, the cover portion (112 and 113) may include an inner cover portion (112-1 and 113-1) disposed in a region adjacent to the capacitance formation portion Ac, and an outer cover portion (112-2 and 113-2) disposed to contact the inner cover portion (112-1 and 113-1).

More specifically, the first cover portion 112 may include a first inner cover portion 112-1 disposed in a region adjacent to the capacitance formation portion Ac, and a first outer cover portion 112-2 disposed to contact the first inner cover portion 112-1, and the second cover portion 113 may include a second inner cover portion 113-1 disposed in a region adjacent to the capacitance formation portion Ac, and a second outer cover portion 113-2 disposed to contact the second inner cover portion 113-1.

The inner cover portion (112-1 and 113-1) and the outer cover portion (112-2 and 113-2) may be formed by arranging or stacking different single second dielectric layers or two or more different second dielectric layers on both end-surfaces of the capacitance formation portion Ac in the first direction.

More specifically, the inner cover portion (112-1 and 113-1) may be formed by arranging or stacking a single 2-1 dielectric layer or two or more 2-1 dielectric layers, and the outer cover portion (112-2 and 113-2) may be formed by arranging or stacking a single 2-2 dielectric layer or two or more 2-2 dielectric layers, and the 2-1 dielectric layer and the 2-2 dielectric layer may have different compositions.

The cover portion (112 and 113) may be formed by sequentially stacking the second outer cover portion 113-2 and the second inner cover portion 113-1, alternately stacking the dielectric layer 111 and the internal electrode (121 and 122) to form the capacitance formation portion Ac, and then sequentially stacking the first inner cover portion 112-1 and the first outer cover portion 112-2, but are not limited thereto.

Unless otherwise specified in the present disclosure, description of the cover portion (112 and 113) may correspond to description of the inner cover portion (112-1 and 113-1) and the outer cover portion (112-2 and 113-2), description of the inner cover portion (112-1 and 113-1) may correspond to description of the first inner cover portion 112-1 and the second inner cover portion 113-1, and description of the outer cover portion 113-1 may correspond to description of the first outer cover portion 112-2 and the second outer cover portion 113-2.

In an embodiment of the present disclosure, the outer cover portion (112-2 and 113-2) may have a different composition from the inner cover portion (112-1 and 113-1), and may include gallium (Ga).

For example, the outer cover portion (112-2 and 113-2) may have a different composition from the composition (e.g., third composition) of the dielectric layer 111 of the capacitance formation portion, or the number of moles of gallium (Ga) relative to 100 moles of titanium (Ti) in the outer cover portion (112-2 and 113-2) may be greater than the number of moles of gallium (Ga) relative to 100 moles of titanium (Ti) in the dielectric layer 111 of the capacitance formation portion Ac. As used herein, the first composition and the third composition may be considered to be different from each other when a difference in the contents of the same element in the first and third compositions is, relative to 100 moles of titanium (Ti), more than ±0.2 mol %, more than ±0.3 mol %, or more than ±1 mol %.

Gallium (Ga) may be a low-temperature sintering agent, and may induce densification of the dielectric microstructure before dielectric grain growth, thereby suppressing creation of pores, and may improve reliability by blocking a breakdown voltage (BDV) and a moisture penetration path caused by an electric field concentration phenomenon.

In addition, when the outer cover portion (112-2 and 113-2) includes glass including silicon (Si), gallium (Ga) may reduce fluidity of the glass, causing the glass to remain on a particle surface, a dielectric grain boundary, or a triple point of the dielectric material. As a result, movement and diffusion of other materials, not the glass, may be activated, thereby increasing sintering densification.

The number of moles of gallium (Ga) relative to 100 moles of titanium (Ti) in the outer cover portion (112-2 and 113-2) may be 0.3 moles or more and 6.0 moles or less.

The number of moles of gallium (Ga) relative to 100 moles of titanium (Ti) included in the outer cover portion (112-2 and 113-2) may be satisfied to be 0.3 mol or more and 6.0 mol or less to lower a sintering temperature of the outer cover portion (112-2 and 113-2), to reduce the number of pores, and therefore, densification of the outer cover portion (112-2 and 113-2) may be improved to improve moisture resistance reliability.

When the number of moles of gallium (Ga) relative to 100 moles of titanium (Ti) included in the outer cover portion (112-2 and 113-2) is less than 0.3 mol, it may not be easy to control dielectric grain growth. Therefore, there may be a concern that pores are excessively formed to lower moisture resistance reliability.

When the number of moles of gallium (Ga) relative to 100 moles of titanium (Ti) included in the outer cover portion (112-2 and 113-2) exceeds 6.0 moles, dispersibility in a dielectric slurry state may be reduced due to excessive addition of gallium (Ga), which may cause occurrence of agglomerates. Therefore, sufficient sintering densification may not be secured or sintering of the cover portion may not proceed.

The inner cover portion (112-1 and 113-1) may not include gallium (Ga).

In addition, the number of moles of gallium (Ga) relative to 100 moles of titanium (Ti) in the outer cover portion (112-2 and 113-2) may be greater than the number of moles of gallium (Ga) relative to 100 moles of titanium (Ti) in the inner cover portion (112-1 and 113-1).

In this case, the fact that the inner cover portion (112-1 and 113-1) does not include gallium (Ga) may refer to a state in which a dielectric slurry or a dielectric green sheet does not include gallium (Ga) before sintering the 2-1 dielectric layer of the inner cover portion (112-1 and 113-1), and may refer to a state in which a region adjacent to the capacitance formation portion Ac among the inner cover portion (112-1 and 113-1) does not include gallium (Ga).

For example, the inner cover portion (112-1 and 113-1) being free of gallium (Ga) may refer to a state in which, even when gallium (Ga) included in the outer cover portion (112-2 and 113-2) undergoes a sintering process such as high-temperature heat treatment or the like, gallium (Ga) does not diffuse into a region of the inner cover portion (112-1 and 113-1) adjacent to the capacitance formation portion Ac among the inner cover portion (112-1 and 113-1), and the inner cover portion (112-1 and 113-1) adjacent to the capacitance formation portion Ac, among the inner cover portion (112-1 and 113-1), does not include gallium (Ga).

For example, the inner cover portion (112-1 and 113-1) being free of gallium (Ga) may refer to a state in which, when a 5 μm×5 μm region adjacent to the capacitance formation portion Ac of the first cover portion 112 or the second cover portion 113 in an SEM-EDS mode, a TEM-EDS mode, or an STEM-EDS mode, based on the first and second direction cross-sections at a center of the first cover portion 112 or the second cover portion 113 in the third direction, gallium (Ga) is not detected or gallium (Ga) is detected at less than 0.1 at %.

Since the inner cover portion (112-1 and 113-1) does not include gallium (Ga), dielectric grain growth according to Ba/Ti molar ratio control of the inner cover portion (112-1 and 113-1) may be more preferably controlled to form small and uniform dielectric grains, to prevent an electric field concentration phenomenon and improve breakdown voltage (BDV) characteristics.

In an embodiment of the present disclosure, if a ratio of the number of moles of barium (Ba) to the number of moles of titanium (Ti) included in the dielectric layer 111 of the capacitance formation portion Ac is A, and a ratio of the number of moles of barium (Ba) to the number of moles of titanium (Ti) included in the cover portion (112 and 113) is C, 1.00<C/A≤1.02 may be satisfied.

More specifically, if the number of moles of titanium (Ti) included in the dielectric layer 111 of the capacitance formation portion Ac is A_{Ti}, and the number of moles of barium (Ba) included in the dielectric layer 111 of the capacitance formation portion Ac is A_{Ba}, a ratio A of the number of moles of barium (Ba) (A_{Ba}) relative to the number of moles of titanium (Ti) included in the dielectric layer 111 of the capacitance formation portion Ac (A_{Ti}) may refer to A_{Ba}/A_{Ti}. And, if the number of moles of titanium (Ti) included in the cover portion (112 and 113) is C_{Ti} and the number of moles of barium (Ba) included in the cover portion (112 and 113) is C_{Ba}, a ratio C of the number of moles of barium (Ba) (C_{Ba}) relative to the number of moles of titanium (Ti) included in the cover portion (112 and 113) (C_{Ti}) may refer to C_{Ba}/C_{Ti}.

In this case, the ratio C of the number of moles of barium (Ba) relative to the number of moles of titanium (Ti) included in the cover portion (112 and 113) may be a concept including a ratio of the number of moles of barium (Ba) to the number of moles of titanium (Ti) included in the inner cover portion (112-1 and 113-1), and a ratio of the number of moles of barium (Ba) to the number of moles of titanium (Ti) included in the outer cover portion (112-2 and 113-2).

By satisfying 1.00<C/A≤1.02, dielectric grain growth of the cover portion (112 and 113) may be controlled to form small and uniform dielectric grains, to prevent an electric field concentration phenomenon and improve breakdown voltage (BDV) characteristics.

In C/A≤1.00, it may be difficult to form small and uniform dielectric grains because dielectric grain growth control is not easy, and in 1.02<C/A, since sintering driving force of the dielectric grains may not be sufficient, densification of the dielectric microstructure and dielectric grain growth may be reduced. Therefore, pores may be excessively generated, which may reduce moisture resistance reliability.

According to an embodiment of the present disclosure, the inner cover portion (112-1 and 113-1) may control dielectric grain growth by controlling a ratio of the number of moles of barium (Ba) to the number of moles of titanium (Ti) in the inner cover portion (112-1 and 113-1), and the outer cover portion (112-2 and 113-2) may control dielectric grain growth by controlling a ratio of the number of moles of barium (Ba) to the number of moles of titanium (Ti), and the number of moles of gallium (Ga) of the outer cover portion (112-2 and 113-2), to improve densification and prevent generation of pores.

Therefore, porosity of the outer cover portion (112-2 and 113-2) may be lower than porosity of the inner cover portion (112-1 and 113-1).

There may be no particular limitation on a method of measuring porosity (%), but a cross-section of a region to be measured may be photographed using a scanning electron microscope (SEM) or the like, and then a percentage of an area of pores may be calculated from images taken using a program capable of observing the pores (e.g., ‘Zootos’). For example, an area of pores relative to a region to be observed may be expressed as a percentage. Other methods and/or tools appreciated by one of ordinary skill in the art, even if not described in the present disclosure, may also be used.

In addition, an average size of the plurality of dielectric grains included in the outer cover portion (112-2 and 113-2) may be larger than an average size of the plurality of dielectric grains included in the inner cover portion (112-1 and 113-1).

For example, an average size of the plurality of dielectric grains included in the outer cover portion (112-2 and 113-2) may be 23% or more and 42% or less larger than an average size of the plurality of dielectric grains included in the inner cover portion (112-1 and 113-1).

More specifically, for example, an average size of the plurality of dielectric grains included in the outer cover portion (112-2 and 113-2) may be 200 nm or more and 320 nm or less, or an average size of the plurality of dielectric grains included in the inner cover portion (112-1 and 113-1) may be 120 nm or more and 220 nm or less, more preferably 160 nm or more and 220 nm or less.

In the present disclosure, the average size of the plurality of dielectric grains may be obtained by photographing a 5 μm×5 μm region of a cross-section of each component including the dielectric grains, for example, the inner cover portion (112-1 and 113-1) or the outer cover portion (112-2 and 113-2), using an SEM, a TEM, or an STEM, and obtaining sizes of the dielectric grains or an average size of the plurality of dielectric grains observed in the photographed images through an image program (for example, ‘Image Pro Plus’ or ‘Image J’). Other methods and/or tools appreciated by one of ordinary skill in the art, even if not described in the present disclosure, may also be used.

In this case, the inner cover portion (112-1 and 113-1) and the outer cover portion (112-2 and 113-2) may be distinguished by different sizes of the dielectric grains included in the inner cover portion (112-1 and 113-1) and the outer cover portion (112-2 and 113-2), and when the distinction is not easy, a region in which gallium (Ga) is detected may be distinguished as the outer cover portion (112-2 and 113-2) and a region in which gallium (Ga) is not detected may be distinguished as the inner cover portion (112-1 and 113-1), through SEM-EDS, TEM-EDS, or STEM-EDS mode analysis, but are not limited thereto.

Since the average size of the plurality of dielectric grains included in the outer cover portion (112-2 and 113-2) may be larger than the average size of the plurality of dielectric grains included in the inner cover portion (112-1 and 113-1), the dielectric microstructure may be densified to reduce the number of pores, or mechanical properties may be enhanced to improve impact resistance.

A percentage (tc2/tc) of a first direction average dimension tc2 of the outer cover portion (112-2 and 113-2) relative to a first direction average dimension tc of the cover portion (112 and 113) may be 50% or more and 80% or less.

For example, when the cover portion (112 and 113) comprises the inner cover portion (112-1 and 113-1) and the outer cover portion (112-2 and 113-2), a percentage of a first direction average dimension tc1 of the inner cover portion (112-1 and 113-1) relative to a first direction average dimension tc of the cover portion (112 and 113) may be 20% or more and 50% or less. For example, a first direction average dimension ratio (tc1:tc2) of the inner cover portion (112-1 and 113-1) and the outer cover portion (112-2 and 113-2) may be 2:8 to 5:5.

In this case, a first direction average dimension of the outer cover portion or the inner cover portion relative to a first direction average dimension of the cover portion, may refer to a percentage of a first direction average dimension of the outer cover portion or the inner cover portion in one cover portion. For example, a percentage (tc2/tc) of a first direction average dimension tc2 of the first outer cover portion 112-2 relative to a first direction average dimension tc of the first cover portion 112 may be 50% or more and 80% or less, or a percentage (tc1/tc) of a first direction average dimension tc1 of the first inner cover portion 112-1 relative to the first direction average dimension tc of the first cover portion 112 may refer to 20% or more and 50% or less. As an example, only the first cover portion 112 has been described, but it will be obvious that the same may be applied to the second cover portion 113.

When the percentage (tc2/tc) of the first direction average dimension tc2 of the outer cover portion (112-2 and 113-2) relative to the first direction average dimension tc of the cover portion (112 and 113) is 50% or more and 80% or less, densification may be improved and the pores may be reduced, to block moisture penetration from the outside and improve moisture resistance reliability characteristics, and when the percentage (tc1/tc) of the first direction average dimension tc1 of the inner cover portion (112-1 and 113-1) relative to the first direction average dimension tc of the cover portion (112 and 113) is 20% or more and 50% or less, breakdown voltage (BDV) characteristics due to an electric field concentration phenomenon may be improved.

When the percentage (tc2/tc) of the first direction average dimension tc2 of the outer cover portion (112-2 and 113-2) relative to the first direction average dimension tc of the cover portion (112 and 113) is less than 50% and the percentage (tc1/tc) of the first direction average dimension tc1 of the inner cover portion (112-1 and 113-1) relative to the first direction average dimension tc of the cover portion (112 and 113) is more than 50%, breakdown voltage (BDV) characteristics may be excellent, but moisture resistance reliability characteristics may not be sufficiently improved.

When the percentage (tc2/tc) of the first direction average dimension tc2 of the outer cover portion (112-2 and 113-2) relative to the first direction average dimension tc of the cover portion (112 and 113) exceeds 80% and the percentage (tc1/tc) of the first direction average dimension tc1 of the inner cover portion (112-1 and 113-1) relative to the first direction average dimension tc of the cover portion (112 and 113) is less than 20%, moisture resistance reliability characteristics may be excellent, but breakdown voltage (BDV) characteristics may not be sufficiently improved.

A thickness tc of the cover portion (112 and 113) does not need to be specifically limited, and the description of the thickness tc of the cover portion (112 and 113) below may refer to a thickness tc of each of the first cover portion 112 and the second cover portion 113.

To more easily achieve miniaturization and high capacitance of the multilayer electronic component, the thickness tc of the cover portion (112 and 113) may be 50 μm or less, is preferably 30 μm or less, and is more preferably 20 μm or less in ultra-small products.

In this case, the thickness tc of the cover portion (112 and 113) may refer to a dimension of the cover portion (112 and 113) in the first direction. In addition, the thickness tc of the cover portion (112 and 113) may refer to an average thickness tc of the cover portion (112 and 113), and may refer to a first direction average dimension of the cover portion (112 and 113).

The first direction average dimension tc of the cover portion (112 and 113) may be measured by scanning images of first and second direction cross-sections of the body 110 with a scanning electron microscope (SEM) at 10,000× magnification. More specifically, it may refer to an average value calculated by measuring the first direction dimension at ten (10) equally spaced points in the second direction of one cover portion in scanned images.

In this case, the first direction average dimension tc1 of the inner cover portion (112-1 and 113-1) and the first direction average dimension tc2 of the outer cover portion (112-2 and 113-2) may also be obtained by the same method.

In addition, the first direction average dimension tc of the cover portion (112 and 113) measured by the above-described method may have a dimension substantially the same as the first direction average dimension of the cover portion (112 and 113) in the first and third direction cross-sections of the body 110.

The multilayer electronic component 100 may include a side margin region (114′ and 115′) disposed in the third direction of the internal electrode (121 and 122).

More specifically, the side margin region (114′ and 115′) may include a first side margin region 114′ disposed between the internal electrode (121 and 122) and the fifth surface 5, and a second side margin region 115′ disposed between the internal electrode (121 and 122) and the sixth surface 6.

The side margin region (114′ and 115′) may refer to a region between third-direction end-surfaces of the first and second internal electrodes 121 and 122 and a boundary surface of the body 110, based on the first and third-direction cross-sections of the body 110, as illustrated.

The side margin region (114′ and 115′) may refer to a ceramic green sheet region excluding the internal electrode (121 and 122), when an internal electrode paste is applied to a ceramic green sheet applied to the capacitance formation portion Ac, except for a region in which the side margin region (114′ and 115′) is formed.

The side margin region (114′ and 115′) may basically play a role in preventing damage to the internal electrode (121 and 122) due to physical or chemical stress.

The first side margin region 114′ and the second side margin region 115′ may not include the internal electrode (121 and 122), and may include the same material as the first dielectric layer 111, for example, may correspond to a portion of the first dielectric layer 111. For example, the first side margin region 114′ and the second side margin region 115′ may include a ceramic material, for example, may include a barium titanate (BaTiO₃)-based ceramic material. For example, the first side margin region 114′ and the second side margin region 115′ may include barium (Ba) and titanium (Ti).

In addition, since the side margin regions (114′ and 115′) may be formed using a dielectric material such as barium titanate (BaTiO₃), and may thus include a dielectric microstructure after sintering. The dielectric microstructure may include a plurality of dielectric grains, grain boundaries disposed between adjacent dielectric grains among the dielectric grains, and triple points disposed at points at which three or more dielectric grains among the dielectric grains are in contact, and may include a plurality of each thereof.

The multilayer electronic component 100 may include a side margin portion (114 and 115) disposed on the third-direction end-surfaces of the body 110.

More specifically, the side margin portion (114 and 115) may include a first side margin portion 114 disposed on the fifth surface 5 of the body 110, and a second side margin portion 115 disposed on the sixth surface 6 of the body 110.

The side margin portion (114 and 115) may refer to a region between third-direction end-surfaces of the first and second internal electrodes 121 and 122 and a boundary surface of the multilayer electronic component 100, based on the first and third-direction cross-sections of the body 110, as illustrated.

The side margin portion (114 and 115) may be formed by applying a conductive paste to a ceramic green sheet applied to the capacitance formation portion Ac, except for a region in which the side margin portion (114 and 115) is formed, to form the internal electrode (121 and 122), and to suppress a step difference caused by the internal electrode (121 and 122), the internal electrode (121 and 122) after stacking may be cut to be exposed from the fifth and sixth surfaces 5 and 6 of the body 110, and then arranging or stacking a single third dielectric layer or two or more third dielectric layers in the third direction on both end-surfaces of the capacitance formation portion Ac.

The side margin portion (114 and 115) may basically play a role in preventing damage to the internal electrode (121 and 122) due to physical or chemical stress.

The first side margin portion 114 and the second side margin portion 115 may not include the internal electrode (121 and 122), and may include the same ceramic material as the first dielectric layer 111 of the capacitance formation portion. For example, the first side margin portion 114 and the second side margin portion 115 may include a ceramic material, for example, may include a barium titanate (BaTiO₃)-based ceramic material. For example, the first side margin portion 114 and the second side margin portion 115 may include barium (Ba) and titanium (Ti).

In addition, since the side margin portion (114 and 115) may be formed using a dielectric material such as barium titanate (BaTiO₃), and may thus include a dielectric microstructure after sintering. The dielectric microstructure may include a plurality of dielectric grains, grain boundaries disposed between adjacent dielectric grains among the dielectric grains, and triple points disposed at points at which three or more dielectric grains among the dielectric grains are in contact, and may include a plurality of each thereof.

A width wm of the side margin portion (114 and 115) does not need to be particularly limited, and the description of the width wm of the side margin portion (114 and 115) below may refer to a width wm of each of the first side margin portion 114 and the second side margin portion 115.

To more easily achieve miniaturization and high capacitance of the multilayer electronic component 100, the width wm of the side margin portion (114 and 115) may be 30 μm or less, and is more preferably 20 μm or less in ultra-small products.

In this case, the width wm of the side margin portion (114 and 115) may refer to a dimension of the side margin portion (114 and 115) in the third direction. In addition, the width wm of the side margin portion (114 and 115) may refer to an average width wm of the side margin portion (114 and 115), and may refer to a third direction average dimension of the side margin portion (114 and 115).

The third direction average dimension of the side margin portion (114 and 115) may be measured by scanning images of first and second direction cross-sections of the body 110 with a scanning electron microscope (SEM) at 10,000× magnification. More specifically, it may refer to an average value calculated by measuring the third direction dimension at ten (10) equally spaced points in the first direction of one side margin portion in scanned images.

In an embodiment of the present disclosure, a structure in which a multilayer electronic component 100 has two external electrodes 131 and 132 is illustrated, but the number, shapes, or the like of the external electrodes 131 and 132 may be changed, depending on a shape of the internal electrode (121 and 122) or other purposes.

The external electrode (131 and 132) may be disposed on the body 110, and may be connected to the internal electrode (121 and 122).

More specifically, the external electrodes 131 and 132 may include first and second external electrodes 131 and 132 disposed on the third and fourth surfaces 3 and 4 of the body 110, respectively, and connected to the first and second internal electrodes 121 and 122, respectively. For example, the first external electrode 131 may be disposed on the third surface 3 of the body, and may be connected to the first internal electrode 121, and the second external electrode 132 may be disposed on the fourth surface 4 of the body, and may be connected to the second internal electrode 122.

In addition, the external electrode (131 and 132) may be disposed to extend on portions of the first and second surfaces 1 and 2 of the body 110, or may be disposed to extend on portions of the fifth and sixth surfaces 5 and 6 of the body 110. For example, the first external electrode 131 may be disposed on portions of the first, second, fifth, and sixth surfaces 1, 2, 5, and 6 of the body 110, and the second external electrode 132 may be disposed on portions of the first, second, fifth, and sixth surfaces 1, 2, 5, and 6 of the body 110.

The external electrode (131 and 132) may be formed of any material as long as they have electrical conductivity, such as metal or the like, and a specific material may be determined in consideration of electrical characteristics, structural stability, or the like, and may further have a multilayer structure.

For example, the external electrode (131 and 132) may include an electrode layer disposed on the body 110, and a plating layer disposed on the electrode layer. In this case, the electrode layer may include a first electrode layer disposed on the body and a second electrode layer disposed on the first electrode layer, and the plating layer may include a first plating layer disposed on the electrode layer, and a second plating layer disposed on the first plating layer, but is not limited thereto. The contents of the electrode layer and the plating layer will be described in more detail below.

For a more specific example of electrode layers 131a, 132a, 131b, and 132b, the electrode layers 131a, 132a, 131b, and 132b may include a first electrode layer (131a and 132a) that may be a sintered electrode including a first conductive metal and glass, or may include a second electrode layer (131b and 132b) that may be a resin-based electrode including a second conductive metal and a resin.

In this case, the conductive metal included in the first electrode layer (131a and 132a) may be referred to as a first conductive metal, and the conductive metal included in the second electrode layer (131b and 132b) may be referred to as a second conductive metal. In this case, the first conductive metal and the second conductive metal may be the same or different from each other, and in a case in which a plurality of conductive metals are included, only some of them may include the same conductive metal, but are not limited thereto.

In addition, the electrode layers 131a, 132a, 131b, and 132b may be formed in a configuration in which the first electrode layer (131a and 132a), which may be a sintered electrode layer, and the second electrode layer (131b and 132b), which may be a resin-based electrode layer, are sequentially formed on the body 110.

The electrode layers 131a, 132a, 131b, and 132b may be formed by transferring a sheet including a conductive metal onto the body, or by transferring a sheet including a conductive metal onto the sintered electrode. Alternatively, the electrode layers may be formed by applying a conductive paste for an external electrode including a conductive metal to the body 110 and then sintering the same, or by dipping the body 110 into a conductive paste for an external electrode including a conductive metal, but are not limited thereto.

A material having excellent electrical conductivity may be used as conductive metal included in the electrode layers 131a, 132a, 131b, and 132b. For example, the conductive metal may include one or more selected from the group consisting of nickel (Ni), copper (Cu), palladium (Pd), silver (Ag), gold (Au), platinum (Pt), tin (Sn), tungsten (W), titanium (Ti), and alloys thereof, but is not limited thereto.

In an embodiment of the present disclosure, the electrode layers 131a, 132a, 131b, and 132b may have a two-layer structure including a first electrode layer (131a and 132a) and a second electrode layer (131b and 132b), and more specifically, the external electrode (131 and 132) may include a first electrode layer (131a and 132a) including a first conductive metal and glass, and a second electrode layer (131b and 132b) disposed on the first electrode layer (131a and 132a) and including a second conductive metal and a resin.

The first electrode layer (131a and 132a) may play a role of improving bonding with the body 110 by including glass, and the second electrode layer (131b and 132b) may play a role of improving bending strength by including resin.

The first conductive metal included in the first electrode layer (131a and 132a) is not particularly limited as long as it is a material that may be electrically connected to the internal electrode (121 and 122) for forming a capacitance, and may include, for example, at least one of nickel (Ni), copper (Cu), palladium (Pd), silver (Ag), gold (Au), platinum (Pt), tin (Sn), tungsten (W), titanium (Ti), and alloys thereof.

The first electrode layer (131a and 132a) may be formed by applying a conductive paste prepared by adding glass frit to first conductive metal particles, and then sintering the same.

The second conductive metal included in the second electrode layer (131b and 132b) may play a role in electrically connecting the first electrode layer (131a and 132a).

The second conductive metal included in the second electrode layer (131b and 132b) is not particularly limited as long as it is a material electrically connected to the first electrode layer (131a and 132a), and may include at least one of nickel (Ni), copper (Cu), palladium (Pd), silver (Ag), gold (Au), platinum (Pt), tin (Sn), tungsten (W), titanium (Ti), and alloys thereof.

The second conductive metal included in the second electrode layer (131b and 132b) may include at least one of a spherical particle or a flake-shaped particle. For example, the second conductive metal may include only flake-shaped particles, or may include only spherical particles, or may be a mixed form of flake-shaped particles and spherical particles. In this case, the spherical particle may also include a shape that may not be completely spherical, for example, a shape in which a length ratio of a major axis and a minor axis (major axis/minor axis) is 1.45 or less. The flake-type particle refers to a particle having a flat and elongated shape, and is not particularly limited, but for example, a length ratio of a major axis and a minor axis (major axis/minor axis) may be 1.95 or more. Lengths of the major and minor axes of the spherical particle and the flake-shaped particle may be measured from images obtained by scanning cross-sections in the first and second directions cut from a central portion of the multilayer electronic component in the third direction with a scanning electron microscope (SEM).

The resin included in the second electrode layer (131b and 132b) may play a role in securing bonding properties and absorbing shock, and is not particularly limited as long as it is mixed with the second conductive metal particle to make a paste, and may include, for example, an epoxy-based resin.

In addition, the second electrode layer (131b and 132b) may further include an intermetallic compound.

The intermetallic compound may be included to further improve electrical connectivity with the electrode layer (131a and 132a). The intermetallic compound may serve to improve electrical connectivity by connecting a plurality of metal particles, and may serve to surround and connect the plurality of metal particles to each other.

In this case, the intermetallic compound may include a metal having a melting point, lower than a curing temperature of a resin. For example, since the intermetallic compound includes a metal having a melting point, lower than a curing temperature of a resin, the metal having a melting point, lower than a curing temperature of a resin, may melt during a drying process and a curing process to form some of metal particles and the intermetallic compound, to surround the metal particles. In this case, the intermetallic compound may include a low melting point metal of 300° C. or less.

For example, the intermetallic compound may include Sn having a melting point of 213 to 220° C. During the drying process and the curing process, Sn may be melted, and the melted Sn may wet the third conductive metal particles having a high melting point, such as Ag, Ni, or Cu, by capillary action, and may react with a portion of Ag, Ni, or Cu metal particles to form intermetallic compounds such as Ag₃Sn, Ni₃Sn₄, Cu₆Sn₅, Cu₃Sn, or the like. Ag, Ni, or Cu that did not participate in the reaction may remain as metal particles.

Therefore, the plurality of metal particles may include one or more of Ag, Ni, and Cu, and the intermetallic compound may include one or more of Ag₃Sn, Ni₃Sn₄, Cu₆Sn₅, or Cu₃Sn.

A plating layer (131c and 132c) may play a role in improving mounting characteristics.

A type of the plating layer (131c and 132c) is not particularly limited, and may be a single plating layer (131c and 132c) including at least one of nickel (Ni), tin (Sn), silver (Ag), palladium (Pd), and alloys thereof, or may be formed as a plurality of layers.

For more specific examples of the plating layer (131c and 132c), the plating layer (131c and 132c) may be a Ni plating layer or a Sn plating layer, and may be in a configuration in which the Ni plating layer and the Sn plating layer are sequentially formed on the electrode layer, or may be in a configuration in which the Sn plating layer, the Ni plating layer, and the Sn plating layer are sequentially formed. In addition, the plating layer (131c and 132c) may include a plurality of Ni plating layers and/or a plurality of Sn plating layers.

A size of the multilayer electronic component 100 does not need to be particularly limited.

To simultaneously achieve miniaturization and high capacitance, since thicknesses of a dielectric layer and an internal electrode should be thinned to increase the number of stacks, a multilayer electronic component 100 having a size of 3216 (length×width: 3.2 mm×1.6 mm) or less may have more noticeable effects according to the present disclosure.

Hereinafter, the present disclosure will be described in more detail through examples, but is intended to help a specific understanding of the present disclosure, and the scope of the present disclosure is not limited by the examples.

### Example

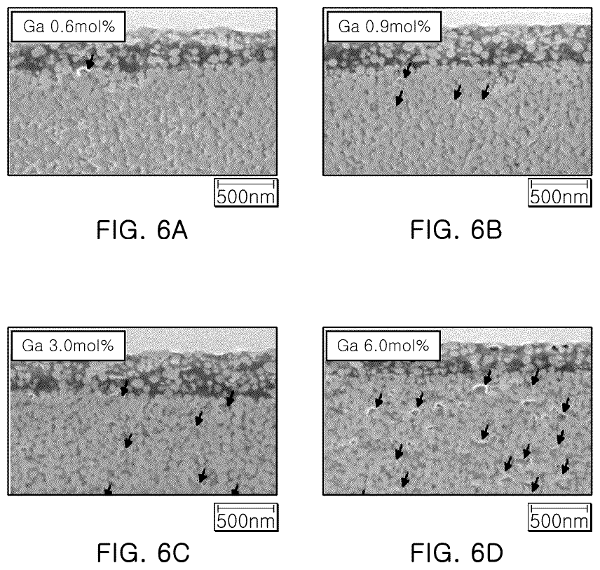

FIGS. 6A to 6D are images taken by a scanning electron microscope (SEM) of cross-sections of cases in which gallium (Ga) is added in different amounts to an outer cover portion in an embodiment of the present disclosure.

More specifically, FIG. 6A illustrates a cross-sectional view of a case in which 0.6 moles of gallium (Ga) relative to 100 moles of titanium (Ti) in the outer cover portion, FIG. 6B illustrates a cross-sectional view of a case in which 0.9 moles of gallium (Ga) relative to 100 moles of titanium (Ti) in the outer cover potion, FIG. 6C illustrates a cross-sectional view of a case in which 3.0 moles of gallium (Ga) relative to 100 moles of titanium (Ti) in the outer cover potion, and FIG. 6D illustrates a cross-sectional view of a case in which 6.0 moles of gallium (Ga) related to 100 moles of titanium (Ti) in the outer cover portion.

Each arrow in images of FIGS. 6A to 6D indicates a region in which gallium (Ga) is aggregated. It can be confirmed that the number of aggregated gallium (Ga) increases, as an amount of gallium (Ga) increases, but it is sufficient to proceed with the sintering. When 7.0 mol of gallium (Ga) was added to the outer cover portion relative to 100 moles of titanium (Ti), since dispersibility was reduced, and the sintering was not completed, observation was not possible.

From this, it can be seen that dispersibility may be improved and the sintering may be completed, when gallium (Ga) is added in an appropriate amount.

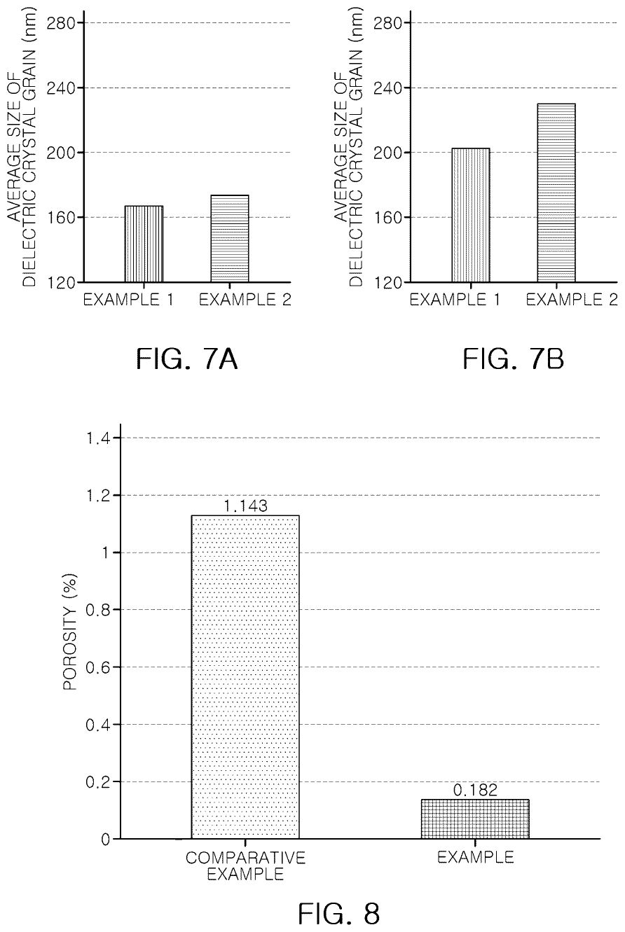

FIG. 7A is a bar graph illustrating an average size of dielectric grains in an inner cover portion of Examples 1 and 2, and FIG. 7B is a bar graph illustrating an average size of dielectric grains in an outer cover portion of the same Examples 1 and 2.

In Example 1, gallium (Ga) was not added to an inner cover portion, and 0.6 mol of gallium (Ga) relative to 100 moles of titanium (Ti) was added to an outer cover portion.

In Example 2, gallium (Ga) was not added to an inner cover portion, and 0.9 mol of gallium (Ga) relative to 100 moles of titanium (Ti) was added to an outer cover portion.

And, in both Examples 1 and 2, if a ratio of the number of moles of barium (Ba) to the number of moles of titanium (Ti) included in a dielectric layer of a capacitance formation portion is A, and a ratio of the number of moles of barium (Ba) to the number of moles titanium (Ti) included in a cover portion is C, it was manufactured to satisfy 1.00<C/A≤1.02. In this case, both the inner cover portion and the outer cover portion were manufactured to satisfy the ratio C.

In Example 1, an average size of dielectric grains of the outer cover portion increased by about 23%, as compared to an average size of dielectric grains of the inner cover portion, and in Example 2, an average size of dielectric grains of the outer cover portion increased by about 42%, as compared to an average size of dielectric grains of the inner cover portion.

From this, it can be seen that gallium (Ga) included in the outer cover portion induces grain growth of the dielectric grains.

FIG. 8 is a bar graph illustrating porosity (%) of an outer region of a cover portion of Comparative Example 1, and a bar graph illustrating porosity (%) of an outer cover portion of Example 3.

Comparative Example 1 was manufactured with a cover portion without adding gallium (Ga).

Example 3 was manufactured with 0.6 mol of gallium (Ga) added to an outer cover portion relative to 100 moles of titanium (Ti) without adding gallium (Ga) to an inner cover portion.

In Comparative Example 1, porosity of an outer region of the cover portion far from a capacitance formation portion Ac was observed to be 1.143%, whereas in Example 1, porosity of an outer cover portion far from a capacitance formation portion Ac was observed to be 0.182%.

From this, it can be seen that the gallium (Ga) included in the outer cover portion induces densification of a dielectric microstructure, to suppress generation of pores and reduce the number of pores.

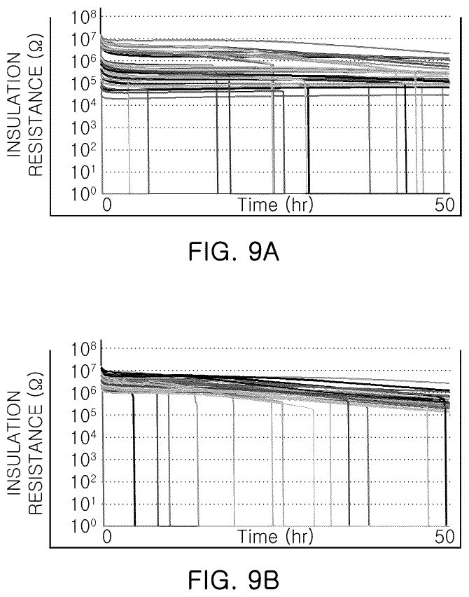

FIG. 9A is a graph for evaluating moisture resistance reliability of Comparative Example 2, and FIG. 9B is a graph for evaluating moisture resistance reliability of Example 4.

Comparative Example 2 was manufactured with a cover portion without adding gallium (Ga).

Example 4 was manufactured with 0.6 mol of gallium (Ga) added to an outer cover portion relative to 100 moles of titanium (Ti) without adding gallium (Ga) to an inner cover portion.

The moisture resistance reliability evaluation was performed under conditions of temperature 105° C., relative humidity 85%, and voltage 1.5 Vr for 50 hours after manufacturing 40 sample chips of Comparative Example 2 and Example 4, respectively.

In Comparative Example 2 and Example 4, sample chips having short defects (or insulation breakdown) were similar, but in Comparative Example 2, most of the sample chips not having short defects had an initial (0 hr to 25 hr) insulation resistance value reduced to 10⁵Ω, whereas in Example 4, most of the chips not having short defects did not have an initial (0 hr to 25 hr) insulation resistance value reduced to 10⁵Ω.

From this, it can be seen that the gallium (Ga) included in the outer cover improves moisture resistance reliability.

In addition, the expression ‘an embodiment’ used in this specification does not mean the same embodiment, and may be provided to emphasize and describe different unique characteristics. However, an embodiment presented above may not be excluded from being implemented in combination with features of another embodiment. For example, although the description in a specific embodiment is not described in another example, it may be understood as an explanation related to another example, unless otherwise described or contradicted by the other embodiment.

The terms used in this disclosure are used only to illustrate various examples and are not intended to limit the present inventive concept. Singular expressions include plural expressions unless the context clearly dictates otherwise.

One of various effects of the present disclosure is to improve moisture resistance reliability of a multilayer electronic component by improving densification of a cover portion to suppress generation of pores.

One of various effects of the present disclosure is to improve withstand voltage characteristics of a multilayer electronic component.

However, various advantages and effects of the present disclosure are not limited to the above-described contents, and may be more easily understood in a process of explaining specific embodiments of the present disclosure.

While example embodiments have been illustrated and described above, it will be apparent to those skilled in the art that modifications and variations could be made without departing from the scope of the present disclosure as defined by the appended claims.

What is claimed is:

1. A multilayer electronic component comprising:
a body including a capacitance formation portion including a dielectric layer and internal electrodes alternately disposed with the dielectric layer in a first direction, and a cover portion disposed on both end surfaces of the capacitance formation portion in the first direction; and
an external electrode disposed on the body,
wherein the dielectric layer and the cover portion include barium (Ba) and titanium (Ti),
the cover portion includes an inner cover portion disposed in a region adjacent to the capacitance formation portion, and an outer cover portion disposed to contact the inner cover portion, and
the outer cover portion has a first composition that is different from a second composition of the inner cover portion, and the outer cover portion includes gallium (Ga).

2. The multilayer electronic component of claim 1, wherein a number of moles of gallium (Ga) relative to 100 moles of titanium (Ti) in the outer cover portion is 0.3 moles or more and 6.0 moles or less.

3. The multilayer electronic component of claim 1, wherein a number of moles of gallium (Ga) relative to 100 moles of titanium (Ti) in the outer cover portion is greater than the number of moles of gallium (Ga) relative to 100 moles of titanium (Ti) in the inner cover portion.

4. The multilayer electronic component of claim 1, wherein the inner cover portion is free of gallium (Ga).

5. The multilayer electronic component of claim 1, wherein the first composition is different from a third composition of the dielectric layer of the capacitance formation portion.

6. The multilayer electronic component of claim 1, wherein a number of moles of gallium (Ga) relative to 100 moles of titanium (Ti) in the outer cover portion is greater than the number of moles of gallium (Ga) relative to 100 moles of titanium (Ti) in the dielectric layer of the capacitance formation portion.

7. The multilayer electronic component of claim 1, wherein the dielectric layer of the capacitance formation portion is free of gallium (Ga).

8. The multilayer electronic component of claim 1, wherein the multilayer electronic component satisfies 1.00<C/A≤1.02, where a ratio (Ba/Ti) of a number of moles of barium (Ba) to a number of moles of titanium (Ti) included in the dielectric layer of the capacitance formation portion is A, and a ratio (Ba/Ti) of the number of moles of barium (Ba) to the number of moles of titanium (Ti) included in the cover portion is C.

9. The multilayer electronic component of claim 1, wherein the cover portion includes a plurality of dielectric grains,
wherein an average size of a plurality of dielectric grains included in the outer cover portion is larger than an average size of a plurality of dielectric grains included in the inner cover portion.

10. The multilayer electronic component of claim 9, wherein the average size of the plurality of dielectric grains included in the outer cover portion is 238 or more and 42% or less larger than the average size of the plurality of dielectric grains included in the inner cover portion.

11. The multilayer electronic component of claim 9, wherein the average size of the plurality of dielectric grains included in the outer cover portion is 200 nm or more and 320 nm or less.

12. The multilayer electronic component of claim 9, wherein the average size of the plurality of dielectric grains included in the inner cover portion is 120 nm or more and 220 nm or less.

13. The multilayer electronic component of claim 1, wherein a porosity of the outer cover portion is lower than a porosity of the inner cover portion.

14. The multilayer electronic component of claim 1, wherein, along the first direction, a percentage of an average dimension of the outer cover portion relative to an average dimension of the cover portion is 50% or more and 80% or less.

15. The multilayer electronic component of claim 1, wherein the body further includes a side margin portion disposed on side surfaces of the capacitance formation portion opposing each other in a third direction, and
along the first direction, the cover portion overlaps the side margin portion.

16. The multilayer electronic component of claim 1, wherein the body further includes a side margin portion disposed on side surfaces of the capacitance formation portion opposing each other in a third direction, and
along the first direction, the cover portion does not overlap the side margin portion.

17. The multilayer electronic component of claim 15, wherein the inner cover portion and the dielectric layer of the capacitance formation portion are free of gallium (Ga),
the multilayer electronic component satisfies 1.00<C/A≤1.02, where a ratio (Ba/Ti) of a number of moles of barium (Ba) to a number of moles of titanium (Ti) included in the dielectric layer of the capacitance formation portion is A, and a ratio (Ba/Ti) of the number of moles of barium (Ba) to the number of moles of titanium (Ti) included in the cover portion is C,
a porosity of the outer cover portion is lower than a porosity of the inner cover portion, and
an average size of a plurality of dielectric grains included in the outer cover portion is larger than an average size of a plurality of dielectric grains included in the inner cover portion.
